(19) United States
(12) Patent Application Publication
(10) Pub. No.: US 2008/0047108 A1
(43) Pub. Date: Feb. 28, 2008

(54) HANDLE STRUCTURE

(75) Inventor: Sun-Fen Yu, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/773,995

(22) Filed: Jul. 6, 2007

(30) Foreign Application Priority Data
Aug. 23, 2006 (TW) 95131029

(51) Int. Cl. A45C 13/22; E05B 1/00

(52) U.S. Cl. 16/408

(57) ABSTRACT

A handle structure includes a gripping portion and a hinge portion. The gripping portion includes a handle and two levers. Each lever has a first hole, a second hole and a groove adjacent to the second hole. The handle is inserted into those second holes by pressing the handle toward the grooves. The hinge portion includes two flexible clamps. Each flexible clamp includes two protrusions against each other. The end with the first hole of the gripping portion presses the two protrusions to move apart from each other. Then, the protrusions are inserted in the first holes, and the gripping portion can swing around the hinge portion.

This application claims the benefit of Taiwan application Serial No. 95131029, filed Aug. 23, 2006, the subject matter of which is incorporated herein by reference.

### BACKGROUND OF THE INVENTION

1. Field of the Invention

The invention relates in general to a handle structure, and more particularly to a handle structure applied to a suitcase or a drawer.

2. Description of the Related Art

Many daily necessities have handles. A user can carry necessities with handles wherever the user is walking or pulls out a drawer with a handle easily. Take a cabinet for example. The most commonly used cabinet is a two-door cabinet. The user can open or close the doors of the cabinet by pulling or pushing the handles on the doors. Take a drawer for another example. Most drawers have handles, so that the user can open or close the drawer by pulling or pushing the handle too. Many package cases of electronic products also have handles. The user can carry the electronic products conveniently through the handles. The handles are usually disposed on the package cases of the electronic products after being manufactured.

The handles can be movable or non-movable. Usually the handles are non-movable, such as the handles on the cabinet doors or the drawers. Hinges are formed between most movable handles and the cases, so that the handles are able to swing relative to the cases. However, this type of hinges is usually more complicated. The hinge normally includes more than two components, such as a base and a pivot. Because the hinge has more components, there are more steps in the assembling process of the handle and the case. As a result, the manufacturing cost of the product is increased accordingly.

### SUMMARY OF THE INVENTION

The invention is directed to a handle structure. Due to the flexible material properties, a base and the pivot of the hinge are combined together to form a flexible clamp so as to simplify the assembly of the handle structure.

According to the present invention, a handle structure including a gripping portion and a hinge portion is provided. The gripping portion includes two first holes. The hinge portion includes two flexible clamps. Each flexible clamp includes two protrusions against each other. The end with the first holes of the gripping portion is pressed against the protrusions so as to push the protrusions outwardly. Then, the protrusions are inserted in the first holes, so that the gripping portion is able to swing around the hinge portion. The gripping portion further includes a handle and two levers. One end of each lever includes a second hole and a groove adjacent to the second hole, and the other end of each lever includes the first hole. The handle is inserted into the second holes by pressing the handle toward the grooves. As a result, the handle is able to rotate around the two levers.

The invention will become apparent from the following detailed description of the preferred but non-limiting embodiments. The following description is made with reference to the accompanying drawings.

### BRIEF DESCRIPTION OF THE DRAWINGS

FIG. 1A illustrates a handle structure according to a preferred embodiment of the present invention;

FIG. 1B illustrates a flexible clamp in FIG. 1A;

FIGS. 2A˜2C illustrate the assembly of a lever and the flexible clamp in FIG. 1A;

FIGS. 3A˜3C illustrate the assembly of the lever and the handle in FIG. 1A;

FIG. 4 illustrates the motion of the handle structure in FIG. 1A; and

FIG. 5 illustrates a suitcase that the handle structure in FIG. 1A is applied to.

### DETAILED DESCRIPTION OF THE INVENTION

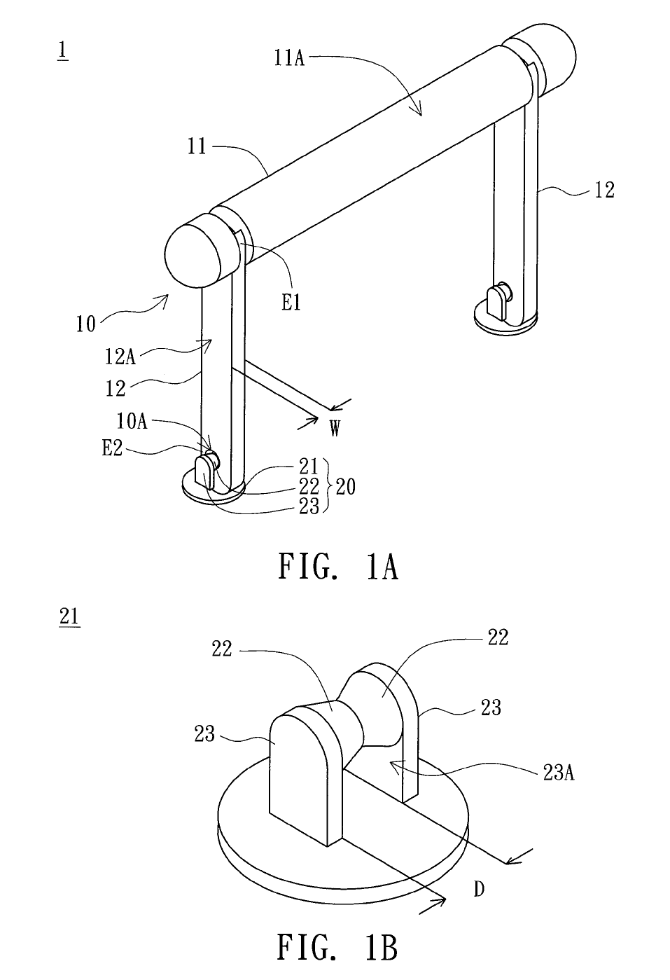

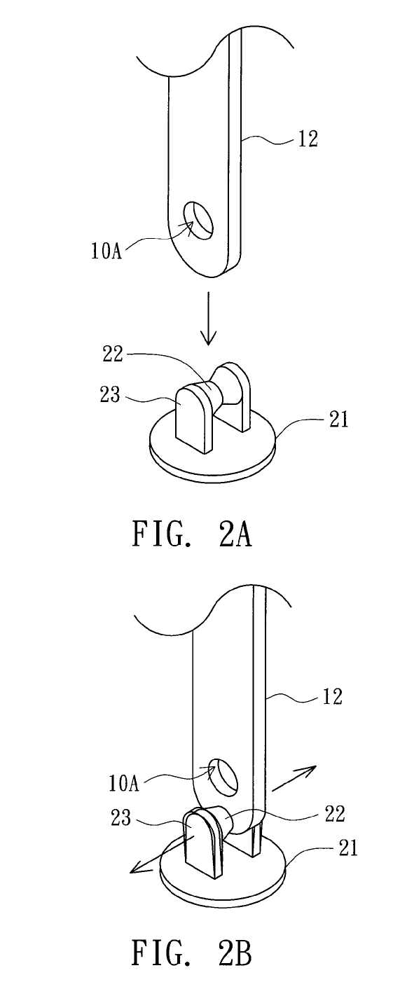

Please referring to FIG. 1A, a handle structure according to a preferred embodiment of the present invention is illustrated. As shown in FIG. 1A, the handle structure 1 includes a gripping portion 10 and a hinge portion 20. The gripping portion 10 includes at least a first hole 10A, and the hinge portion 20 includes at least a flexible clamp 21. The flexible clamp 21 includes two protrusions 22 against each other. In order to insert the protrusions 22 into the first hole 10A, the two protrusions 22 are pushed away from each other. For example, one end with the first hole 10A of the gripping portion 10 is pressed against the protrusions 22 so as to move protrusions 22 outwardly. Then, the protrusions 22 are inserted into the first hole 10A, and the gripping portion 10 is able to swing around the hinge portion 20.

Practically, only one hole and one flexible clamp are needed for forming the handle structure. For illustration, the gripping portion 10 of the handle structure 1 includes two first holes 10A, and the hinge portion 20 includes two flexible clamps 21 in the embodiment.

Preferably, the gripping portion 10 is formed by a handle 11 and two levers 12. Each lever 12 has a first end E1 and a second end E2. The two first ends E1 are connected to two side of the handle 11. The two second ends E2 are connected to the hinge portions 20 respectively. The two first holes 10A are positioned on the second ends E2 of the levers 12 respectively. The two levers 12 are connected with the two flexible clamps 21 through the first holes 10A. For example, the first ends E1 of the levers 12 can be hinged to the two side of the handle 11. Practically, the handle 11 and the levers 12 can be formed as a whole. In the present embodiment, the levers 12 are hinged on the handle 11 as an example. Each lever 12 has a thickness W.

Please refer to both FIG. 1A˜1B. FIG. 1B illustrates the flexible clamp in FIG. 1A. As shown in FIG. 1B, the flexible clamp 21 includes two supporting legs 23 adjacent to each other. The protrusions 22 protrude from two opposite surfaces 23A of the two supporting legs 23 respectively. A distance D is between the two supporting legs 23. Preferably, the distance D is not less than the thickness W of the levers 12 substantially. Therefore, the levers 12 are able to swing smoothly without interfering with the supporting legs 23 after the levers 12 are assembled with the flexible clamps 21. When leaning against each other, the two protrusions 22 preferably form a column as a hinge of the gripping portion 10. Furthermore, the protrusions 22 are preferably cone-shaped. The cone structure has a largest surface and a smallest surface. The largest surfaces of the protrusions 22 are connected with the surfaces 23A of the supporting legs 23 for increasing the strength between the protrusions 22 and the supporting legs 23. The smallest surfaces of the protrusions 22 are substantially leaned against each other. The supporting legs 23 and the protrusions 22 of the flexible clamp 21 can be formed as a whole. The flexible clamp 21 is preferably made of a flexible material, such as plastic or elastic rubber.

The assembly of the handle structure 1 is described with the following to illustrate the present invention more clearly. The assembly of the levers 12 and the flexible clamps 21 is illustrated first.

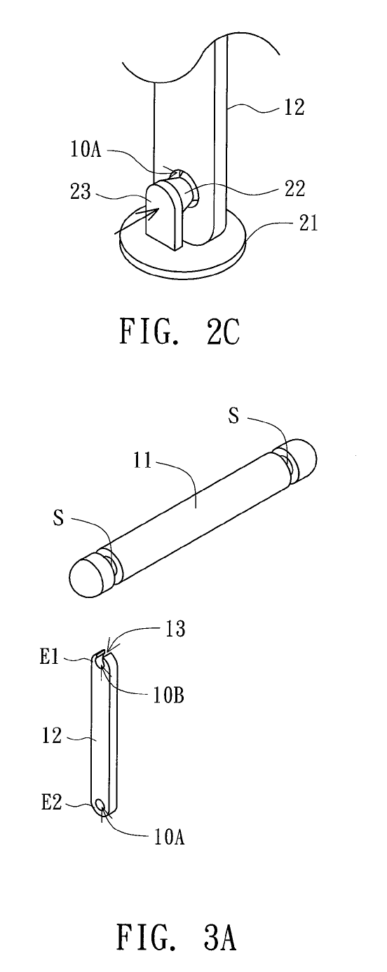

Please referring to FIGS. 2A˜2C at the same time, the assembly of the lever and the flexible clamp in FIG. 1A is illustrated. As shown in FIG. 2A, when assembled with the flexible clamp 12, one end of the lever 12 with the first hole 10A points to the flexible clamp 12 first. Then the lever 12 is moved toward the protrusions 22 and against the protrusions 22.

Next, as shown in FIG. 2B, the lever 12 is pressed toward the protrusions 22. The lever 12 can push the protrusions 22 away from each other because of the material properties of the flexible clamp 21 and the cone-shape of the protrusions 22. Meanwhile, the supporting legs 23 are forced to move outwardly, so that the end of the lever 12 with the first hole 10A is placed between the two protrusions 22.

Then, as shown in FIG. 2C, the lever 12 is moved continuously until the first hole 10A reaches the target position between the two protrusions 22. Because the lever 12 no longer presses the protrusions 22, the supporting legs 23 goes back to the original position. The protrusions 22 are then inserted into the first hole 10A, so that the lever 12 and the flexible clamp 21 are hinged together.

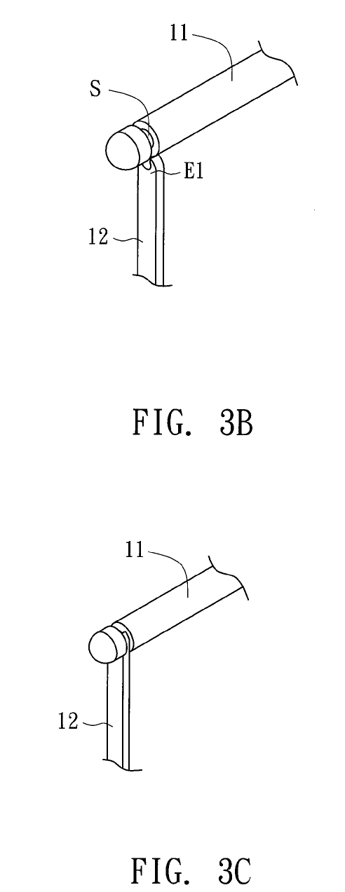

Please referring to FIGS. 3A˜3C, the assembly of the lever 12 and the handle 11 in FIG. 1A is illustrated. The handle 11 preferably includes two axles S, and two second holes 10B are preferably formed at the first ends E1 of the levers 12 (referring to FIG. 1A). Only one lever 12 is shown in FIG. 3A as an example. A groove 13 is formed in each lever 12 and adjacent to the second hole 10B. The axle S of the handle 11 is lodged into the second hole 10B by pressing the first end E1 of the lever 12 with the groove 13 toward the axle S.

Preferably, the levers 12 are made of plastic. As shown in FIG. 3B, when the handle 11 is pressed toward the groove 13, the first end E1 of the lever 12 moves outwardly due to its material properties. As a result, the axle S is able to pass through the groove 13 and lodged into the second hole 10B.

When the axle S of the handle 11 reaches the target position, the axle S no longer presses the groove 13 of the lever 12. Therefore, the groove 13 goes back to the original shape. Accordingly, the handle 11 is connected with the lever 12 as shown in FIG. 3C.

What is worth mentioning is that the width of the groove 13 and the diameter of the second hole 10B have to be within a certain range. Practically, the width of the groove 13 is substantially smaller than the diameter of the second hole 10B. When the width of the groove 13 is too small, larger force has to be applied to the handle 11 for pressing the axle S through the groove 13. As a result, the lever 12 or the handle 11 is easily deformed permanently. When the width of the groove 13 is too large (still less than the diameter of the second hole 10B), the handle 11 can be assembled with the lever 12 very easily. However, the first end E1 of the lever 12 has insufficient connection with the axle S, so the handle 11 and the lever 12 are easily separated apart.

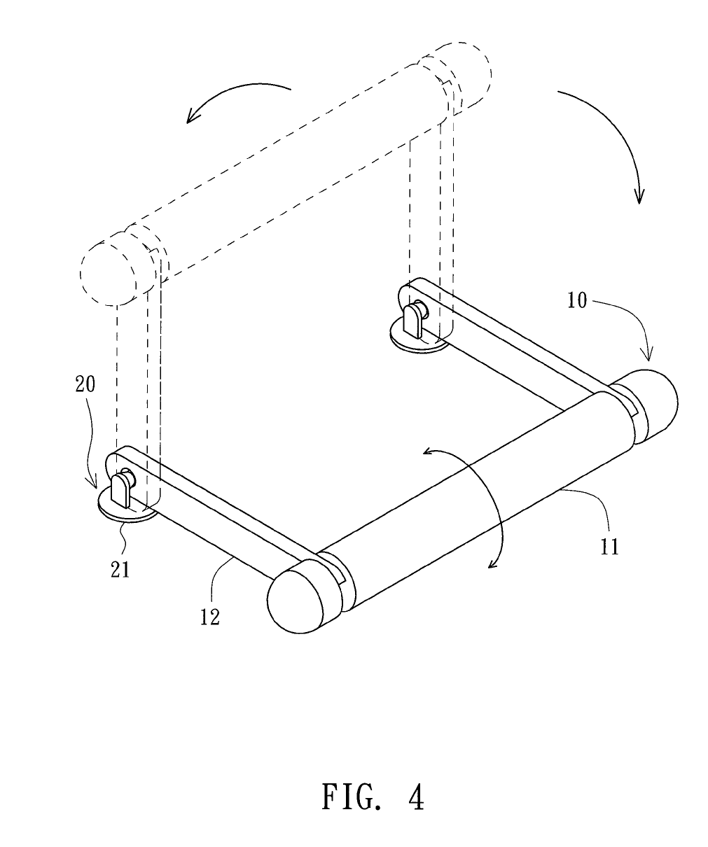

Please referring to FIG. 4, the motion of the handle structure in FIG. 1A is illustrated. As shown in FIG. 4, when the handle 1, the levers 12 and the flexible clamps 21 are assembled together, the whole gripping portion 10 is able to swing around the hinge portion 20 up to 180°. Also, the handle 11 is able to rotate around the lever 12.

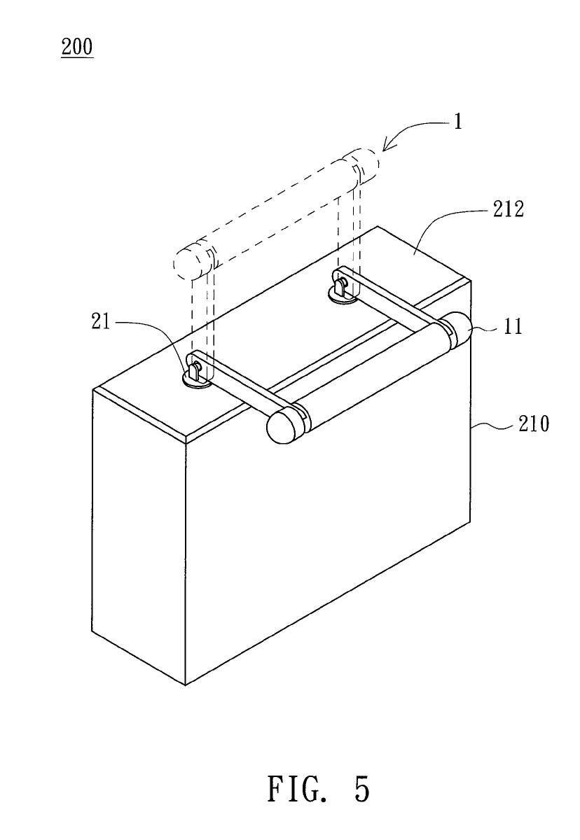

Please referring to FIG. 5, a suitcase that the handle structure in FIG. 1A is applied to is illustrated. As shown in FIG. 5, the suitcase 200 includes a case 210 and the handle structure 1. The handle structure 1 can be positioned in any place on the case 210 according to different purpose. The flexible clamps 21 are preferably disposed on a top plate 212 of the case 210. When a user wants to carry the suitable 200, the user just needs to swing the handle 11 to a vertical position then the user can easily carry up the suitcase 200. When the case 210 is larger, several handle structures 1 can be deposed on the suitcase 200 to increase stability.

The flexible clamps 21 can be disposed on the case 210 through many different methods. For example, the flexible clamps 12 can be adhered to the top plate 212 of the case 210. Or, the flexible clamps 12 and the case 210 can be formed as a whole. Because of the material properties of the flexible clamp 21, the handle structure 1 can be assembled with the case 210 easily.

The case 210 can be a package case for different electronic products, such as computers, displays or consumer electronics. The case provides protection for the electronic products after the electronic products are manufactured and before they are delivered to consumers, so that the electronic products would not be damaged during the shipping. Users can carry cases through the handle structures easily.

Anyone who has ordinary skill in the field of the present invention can understand that the present invention is not limited to the above description. For example, the handle structure 1 can be applied to any product that a user holds with hand. Furthermore, the handle structure 1 can also be applied to a drawer or a cabinet.

Moreover, a decoration pattern can be formed on the handle 11 of the handle structure 1. For example, the decoration pattern is formed on a holding surface 11A (shown in FIG. 1A) of the handle 11 to improve the texture quality of the handle 11. Similarly, another decoration pattern can be formed on a surface 12A of the lever 12. The decoration pattern is preferably the trademark of the manufacturer so as to mark the handle structure as its product.

In the handle structure of the above embodiment, the flexible clamp is served as a hinge, and the holes and the groove are formed on the lever accordingly. When assembling the handle and the lever, the handle is pressed toward the groove of the lever for connecting the handle and the lever. When assembling the lever and the flexible clamp, the lever is pressed against the flexible clamp for connecting the lever and the flexible clamp. It is very easy to assemble the handle structure. Also, the lever and the flexible clamp are made of materials that are easily obtained. Furthermore, the flexible clamp is preferably formed as a whole by injection molding, so that the handle structure has simple structure and low manufacturing cost. Preferably, decoration patterns are formed on the handle structure so as to improve the texture quality of the handle structure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handle structure comprising:
a gripping portion having at least a first hole; and
a hinge portion including at least a flexible clamp, the flexible clamp having two protrusions against each other;
wherein the two protrusions are inserted in the first hole after one end with the first hole of the gripping portion is pressed against the protrusions so as to push the protrusions outwardly, the gripping portion is able to swing around the hinge portion.

2. The structure according to claim 1, wherein the gripping portion comprises two first holes, the hinge portion comprising two flexible clamps.

3. The structure according to claim 2, wherein each flexible clamp comprises two supporting legs adjacent to each other, the two supporting legs have two opposite surfaces, and the two protrusions protrude from the two surfaces respectively.

4. The structure according to claim 2, wherein the protrusions are cone-shaped.

5. The structure according to claim 2, wherein the gripping portion comprises a handle and two levers, one end of each lever is disposed on one side of the handle, and the two first holes are positioned on the other end of the two levers.

6. The structure according to claim 5 wherein the two levers are hinged on the handle respectively.

7. The structure according to claim 5, wherein each lever comprises a second hole and a groove, the two second holes are positioned on the end of the levers, the handle is inserted in the second holes by pressing the handle toward the grooves.

8. The structure according to claim 7, wherein a width of the grooves is substantially smaller than a diameter of the second holes.

9. The structure according to claim 5, wherein the handle and the levers are formed as a whole.

10. The structure according to claim 5, wherein the two levers are made of plastic.

11. The structure according to claim 5, wherein a decoration pattern is formed on a holding surface of the handle.

12. The structure according to claim 5, wherein a decoration pattern is formed on the surfaces of the levers.

13. The structure according to claim 2, wherein the two flexible clamps are disposed on a case or a box.

14. The structure according to claim 2, wherein the two flexible clamps are made of plastic.
